(19) United States
(12) Patent Application Publication
(10) Pub. No.: US 2025/0363303 A1
(43) Pub. Date: Nov. 27, 2025

(54) MASKED DIFFUSION MODELS WITH STATE-DEPENDENT MASKING SCHEDULES

(71) Applicant: GDM Holding LLC, Mountain View, CA (US)

(72) Inventors: Jiaxin Shi, London (GB); Kehang Han, Los Angeles, CA (US); Arnaud Doucet, Oxford (GB); Michail Titsias, London (GB)

(21) Appl. No.: 19/216,465

(22) Filed: May 22, 2025

(30) Foreign Application Priority Data
May 22, 2024 (GR) 20240100389

(51) Int. Cl. G06F 40/284

(52) U.S. Cl. CPC G06F 40/284

(57) ABSTRACT

Methods, systems, and apparatus, including computer programs encoded on computer storage media, for generating an output sequence that includes a respective token selected from a vocabulary of tokens at each of multiple output positions. In one aspect, one of the methods includes obtaining an initial output sequence, the initial output sequence comprising a mask token at each of at least a subset of the multiple output positions; repeatedly performing the following at each of multiple update iterations: obtaining an intermediate representation of the output sequence; generate a diffusion model output that comprises, for each of the multiple output positions, a respective score for each token in at least a subset of the vocabulary of tokens; determining, for each output position in the output sequence that is occupied by a mask token, a masked probability; selecting a subset of the multiple output positions; and generating an updated intermediate representation.

### CROSS-REFERENCE TO RELATED APPLICATIONS

This application claims priority to Greek national patent application number GR 20240100389, filed on May 22, 2024. The disclosure of the prior application is considered part of and is incorporated by reference in its entirety in the disclosure of this application.

### BACKGROUND

This specification relates to using neural networks to generate data.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates output sequences in response to received requests.

Generative models, particularly diffusion models, have shown promise in creating diverse and high-quality data across various modalities. However, existing discrete diffusion models often face challenges in achieving optimal output quality, particularly for complex structured data like long text sequences or high-resolution images, without incurring significant computational costs during inference or requiring complex training objectives. A technical problem is to improve the quality and coherence of generated sequences while maintaining or reducing computational demands and simplifying the training regimen. Specifically, there is a desire for a diffusion process that offers more fine-grained control over the token generation or unmasking order, thereby enabling the model to learn and reproduce complex dependencies within the data more effectively, leading to a technical improvement in the generated output's fidelity to real data distributions and its utility in downstream technical applications.

Furthermore, controlling the generation process in diffusion models to, for example, prioritize the generation of certain structural elements or features within a sequence before others, remains a challenge. Existing methods may unmask tokens in a fixed or random order, which can be suboptimal for learning complex data distributions where the significance of a token can depend on its context, which is itself being constructed. This lack of adaptive control can lead to inefficiencies in the learning process and suboptimal quality in the generated outputs, such as reduced coherence in text or artifacts in images. Therefore, a technical challenge lies in devising a masking strategy within a diffusion framework that is adaptive and state-dependent, guiding the model to construct sequences in a more structured and technically meaningful way.

In general, one innovative aspect of the subject matter described in this specification can be embodied in a computer-implemented method for generating an output sequence that comprises a respective token selected from a vocabulary of tokens at each of a plurality of output positions, wherein the method comprises: obtaining an initial output sequence, the initial output sequence comprising a mask token at each of at least an initial subset of the plurality of output positions; repeatedly performing the following at each of multiple update iterations: obtaining an intermediate representation of the output sequence; processing a diffusion model input that comprises the intermediate representation using the diffusion model to generate a diffusion model output that comprises, for each of the plurality of output positions, a respective score for each token in at least a subset of the vocabulary of tokens; determining, for each output position in the output sequence that is occupied by a mask token and based on the intermediate representation, a masked probability that defines a probability of the output position remaining to be occupied by the mask token; selecting a subset of the plurality of output positions in the output sequence to be unmasked based on the masked probability that has been determined for each output position in the output sequence that is occupied by the mask token; and generating an updated intermediate representation of the output sequence, wherein generating the updated intermediate representation comprises selecting, for each output position in the subset and based on the diffusion model output generated by the diffusion model, a respective token from the vocabulary of tokens to occupy the position.

These and other embodiments can each optionally include one or more of the following features.

The method may further comprise determining an unmasked probability that defines a probability of the output position ceasing to be occupied by the mask token, wherein determining the unmasked probability may comprise: a weighted combination of the respective score for each token at least the subset of in the vocabulary of tokens, wherein each respective score in the weighted combination is weighted by a weight that is dependent on a learnable parameter associated with the token.

The weight may also be dependent on a time index that identifies an update iteration in the multiple update iterations.

Selecting the subset of the plurality of output positions in the output sequence to be unmasked based on the masked probability that has been determined for each output position in the output sequence that is occupied by the mask token may comprise: selecting one or more output positions in the output sequence to be included in the subset by prioritizing for selection output positions in the output sequence that have relatively lower masked probabilities.

Selecting, for each output position in the subset and based on the diffusion model output generated by the diffusion model, the respective token from the vocabulary of tokens to occupy the position may comprise: selecting, as the respective token to occupy the position, a token from the vocabulary of tokens in accordance with the respective score for each token in at least the subset of the vocabulary of tokens that has been generated by the diffusion model.

The respective score for each token in at least the subset of the vocabulary of tokens may be a probability score generated by a softmax layer of the diffusion model.

The diffusion model may have been trained jointly with the learnable parameters on a plurality of masked training sequences that each include mask tokens, the mask tokens being added based on original tokens included in a plurality of training sequences.

Training the diffusion model may comprise: obtaining a training sequence that includes an original token at each of a plurality of output positions; obtaining a time index that identifies a forward masking iteration; determining, for each output position in the training sequence, a masked probability of replacing the original token at the output position with a mask token based on the time index; and generating a masked training sequence by assigning mask tokens to one or more of the plurality of output positions in the training sequence in accordance with the masked probabilities.

Training the diffusion model may comprise: processing the masked training sequence using the diffusion model to generate a diffusion model output that comprises, for each of the one or more of the plurality of output positions in the masked training sequence, a respective training score for each token in at least the subset of the vocabulary of tokens; and updating values of parameters of the diffusion model based on optimizing a diffusion objective function that comprises a weighted integral of cross-entropy loss terms, the cross-entropy loss terms comprising, for each of the one or more of the plurality of output positions in the masked training sequence, a cross-entropy loss term that evaluates a difference between (i) the respective training score for each token in at least the subset of the vocabulary of tokens and (ii) a predetermined score for each token in at least the subset of the vocabulary of tokens.

In the weighted integral of cross-entropy loss terms, each cross-entropy loss term may be weighted by a weight that is dependent on the time index.

Training the diffusion model jointly with the learnable parameters may comprise: computing gradients of the diffusion objective function with respect to the learnable parameters using a REINFORCE leave-one-out (RLOO) technique.

The tokens may comprise tokens that represent text characters, symbols, or audio signals.

The tokens may comprise tokens that represent image data, video data, or audio data.

Another innovative aspect of the subject matter described in this specification can be embodied in a computer-implemented method for training a diffusion model having a plurality of parameters, wherein the method comprises: obtaining a training sequence that includes an original token at each of a plurality of output positions; obtaining a time index that identifies a forward masking iteration; determining, for each output position in the training sequence, a masked probability of replacing the original token at the output position with a mask token based on the time index; and generating a masked training sequence by assigning mask tokens to one or more of the plurality of output positions in the training sequence in accordance with the masked probabilities; processing the masked training sequence using the diffusion model to generate a diffusion model output that comprises, for each of the one or more of the plurality of output positions in the masked training sequence, a respective training score for each token in at least the subset of the vocabulary of tokens; and updating values of the plurality of parameters of the diffusion model based on optimizing a diffusion objective function that comprises a weighted integral of cross-entropy loss terms, the cross-entropy loss terms comprising, for each of the one or more of the plurality of output positions in the masked training sequence, a cross-entropy loss term that evaluates a difference between (i) the respective training score for each token in at least the subset of the vocabulary of tokens and (ii) a predetermined score for each token in at least the subset of the vocabulary of tokens.

In the weighted integral of cross-entropy loss terms, each cross-entropy loss term may be weighted by a weight that is dependent on the time index.

Other embodiments of these aspects include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The subject matter described in this specification can be implemented in particular embodiments so as to realize one or more of the following advantages.

By making use of the described techniques to implement a masked diffusion process, the quality of the output sequences generated by using a diffusion model can be improved without additional computational or memory resource overhead at inference time compared to existing discrete diffusion models. Additionally, the training process of the diffusion model can be simplified; the training process can use a training objective function that includes a weighted integral over time of cross-entropy loss terms, e.g., rather than existing, more complex objective functions. By using the weighted integral, the training objective function is simpler and require a smaller amount of computational resources to evaluate, thereby enabling a training system to preserve computational resource at training time.

This preservation of computational resources during training is not merely due to simpler evaluation of the objective function per step, but also stems from the potential for more efficient learning dynamics. The principled weighting scheme within the training objective, derived from the rules governing how tokens become unmasked, can guide the optimization process more effectively. This may lead to faster convergence towards a model that generates high-quality sequences, thereby reducing the overall number of training epochs and associated computational cost required to reach a target performance level for a specific technical application, such as generating medical images of diagnostic quality or producing functionally plausible protein sequences.

The masked diffusion process enables parallel generation of multiple tokens at any given update iteration, thereby achieving a faster token generation process compared to auto-regressive models which generate one token after another for an output sequence. This parallel generation capability provides a significant technical advantage for systems where generation latency is critical. Unlike autoregressive models that sequentially predict tokens one by one, the proposed masked diffusion process, at each update iteration can predict and fill multiple currently masked positions simultaneously based on the diffusion model's output. This significantly reduces the number of sequential steps required to generate a complete sequence of a certain length from a one-by-one approach (for pure autoregressive models) to a much smaller number of diffusion steps (e.g., a total number of update iterations that can be significantly less than the sequence length), leading to a substantial technical effect of reduced inference time and increased throughput for sequence generation tasks. This is particularly beneficial for applications requiring real-time or near real-time generation.

Furthermore, by, at any given update iteration, determining whether an output position in an output sequence should be unmasked based on a masked probability for each output position in the output sequence that is dependent on a time index that identifies the given update iteration and, optionally, a set of learned parameters associated with tokens in a vocabulary, the system follows a controllable order across multiple update iterations when incrementally updating—or, unmasking—an initial output sequence that includes mask tokens. Such a controllable order enables the diffusion model to generate higher quality output sequences compared to existing diffusion models.

This controllable order may be achieved as the state-dependent masking schedule, by incorporating the current stage of the generation process and, optionally, learned token-specific settings, facilitates the system in modulating the probability of a placeholder token persisting at each position. For example, if certain tokens (e.g., tokens representing fundamental structural elements of a sequence, or tokens that are statistically easier to predict early on) have learned settings within their specific unmasking rules that cause the likelihood of them remaining masked to decrease more rapidly as the generation progresses, these tokens are more likely to be unmasked (i.e., sampled from the vocabulary) earlier in the generative process. Thus, the model may establish a foundational structure or context first, upon which more complex or nuanced details can be subsequently built. This structured generation, akin to a coarse-to-fine approach but learned implicitly, reduces the likelihood of generating incoherent or globally inconsistent sequences, thereby contributing to the technical effect of higher output quality, as measured by metrics like Bits Per Character or Bits Per Dimension. For instance, in text generation, this could mean generating key nouns or verbs that define the sentence's core meaning before elaborating with adjectives or adverbs. In image generation, this could involve sketching out primary object outlines before rendering textures.

For example, a validation perplexity on text sequences from the Open WebText dataset generated by using the diffusion model can be improved, e.g., relative to text sequences generated by other known discrete diffusion-based methods. As another example, a Bits Per Character (BPC) metric on text sequences from the Text8 dataset generated by using the diffusion model can be improved, e.g., relative to text sequences generated by other known discrete diffusion-based methods. As another example, a Bits Per Dimension (BPD) metric on image data generated by using the diffusion model can be improved. As a particular example, the diffusion model trained using the described techniques can achieve 2.75 BPD on generation of CIFAR-10 images and 3.40 BPD on generation of ImageNet 64×64 images, which improve over existing autoregressive models and existing discrete diffusion models of comparable sizes by a significant margin.

This efficiency makes the described masked diffusion models particularly well-suited for deployment in resource-constrained environments. Such environments include mobile devices, embedded systems in IoT applications, or edge computing nodes where both memory footprint and processing power are limited. The ability to generate high-quality sequences without demanding excessive computational resources enables a broader range of on-device AI applications, for instance, on-the-fly image style transfer in a portable camera system or rapid anomaly detection based on generated sensor data baselines in industrial equipment. This represents a significant technical advantage over more resource-intensive generative models that may require cloud offloading for similar tasks.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system and an example inference system.

FIG. 2 is a flow diagram of an example process for training a diffusion model.

FIG. 3 is an example illustration of operations performed to train a diffusion model.

FIG. 4 is a flow diagram of an example process for generating an output sequence by using a diffusion model.

FIG. 5 is an example illustration of generating an output sequence by using a diffusion model.

FIG. 6 shows an example of the performance of the diffusion model on a text generation task.

FIG. 7 shows an example of the performance of the diffusion model on an image generation task.

Like reference numbers and designations in the various drawings indicate like elements.

### DETAILED DESCRIPTION

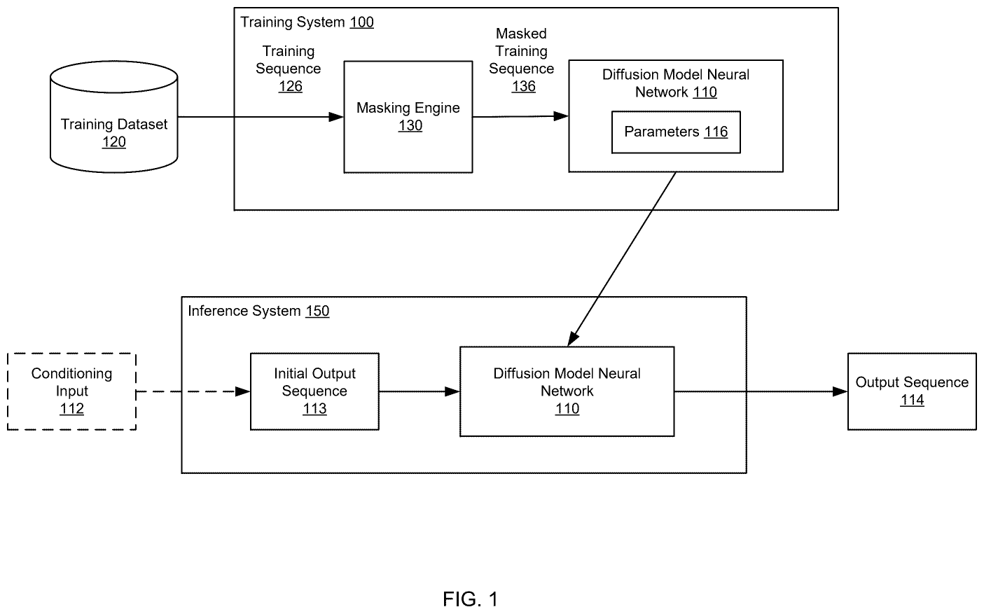

FIG. 1 shows an example training system 100 and an example inference system 150. The training system 100 and the inference system 150 are examples of a system implemented as computer programs on one or more computers in one or more locations, in which the systems, components, and techniques described below can be implemented.

The training system 100 trains a diffusion model neural network 110 (referred to below as a “diffusion model 110” for short) for the inference system 150 to use, i.e., to generate output sequences 114 in response to received requests.

In operation, the inference system 150 receives a request for an output sequence 114 and, in response, generates an initial output sequence 113 and uses the diffusion model 110 to generate the output sequence 114 based on the initial output sequence 113 by performing a masked diffusion process that includes multiple update iterations.

The initial output sequence 113 includes a respective token at each of a plurality of output positions, and the output sequence 114 includes a respective token at each of the plurality of output positions.

Each token included in the output sequence 114 is selected from a vocabulary of tokens. The vocabulary of tokens includes a finite number of possible tokens.

The vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally or alternatively, the vocabulary of tokens can include tokens that can represent data other than text.

For example, the vocabulary of tokens can include image tokens that represent a discrete set of image patch embeddings of an image that can be generated by an image encoder neural network based on processing the image patches of the image. Here an image may be defined by image data including at least one intensity value, e.g., any value within [0, 255], for each pixel of an (e.g. two-dimensional) pixel array, and the image patch embeddings may be embeddings of the intensity values for the pixels of respective (e.g. non-overlapping) portions of the array. Thus, the image tokens encode pixel-level data about the image.

As another example, the vocabulary of tokens can include image tokens that each correspond to an image patch of the image. Generally, each image patch includes multiple contiguous pixels of the image. For example, each image token can be represented as a one-dimensional or two-dimensional sequence of the pixels of the image patch.

As a similar example, the vocabulary of tokens can include point cloud tokens that represent a discrete set of point cloud segment embeddings of a point cloud that can be generated by a point cloud encoder neural network based on processing the point cloud segments of the point cloud.

As another example, the vocabulary of tokens can include audio tokens that represent code vectors in a codebook of a quantizer, e.g., a residual vector quantizer. The audio tokens may include sound amplitude and/or frequency data for each of a sequence of times contained within (and spanning) a time period.

As another example, the vocabulary of tokens can include biological tokens that represent biological data, e.g., nucleotides or amino acids.

Furthermore, the vocabulary may include any two or more of text tokens, image tokens (defining one image or a sequence of images, e.g. frames of a video), audio tokens and biological tokens. In particular, it may include both text tokens and also image tokens and/or audio tokens.

Unlike the output sequence 114 that includes tokens selected from the vocabulary of tokens and thus, includes no mask tokens, the initial output sequence 113 includes a mask token at each of at least a subset of the plurality of output positions. A mask token is a special token that signifies that a token has not been selected from the vocabulary for the corresponding output position occupied by the mask token. That is, the mask token is not in the vocabulary of tokens and serves as a “placeholder” to indicate that a position does not yet have a token from the vocabulary.

In some cases, the initial output sequence 113 is entirely made up of mask tokens, while in other cases, the initial output sequence 113 includes mask tokens at a first subset of the plurality of output positions and conditioning tokens at a second subset of the plurality of output positions. The conditioning tokens can include tokens that are selected from the vocabulary of tokens.

By performing the masked diffusion process, the inference system 150 progressively removes the mask tokens from the initial output sequence 113.

At each of the multiple update iterations in the masked diffusion process, the inference system 150 selects a subset of the plurality of output positions in the output sequence to be unmasked. Each output position selected to be unmasked is occupied by a mask token.

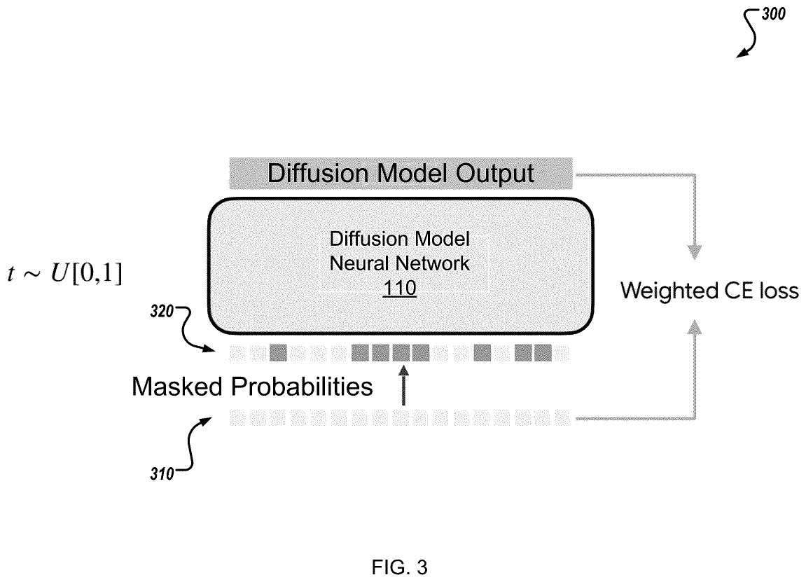

In particular, the inference system 150 selects the output positions to be unmasked based on a masked probability that is determined for each output position in the output sequence. As will be explained further below with reference to FIG. 3, such a masked probability is determined based on a diffusion model output generated by the diffusion model 110 for the update iteration.

Then, at each update iteration, the inference system 150 selects, for each output position in the subset and based on the diffusion model output generated by the diffusion model 110 for the update iteration, a respective token from the vocabulary of tokens to occupy the output position which is currently occupied by the mask token. That is, the inference system 150 replaces the mask token that currently occupies the output position with the respective token selected from the vocabulary of tokens. Thus, the initial output sequence 113 is, in the first update iteration, modified to a first modified output sequence having fewer mask tokens than the initial output sequence. In each l-th iteration (where l is an integer in the range 2 to an integer T which is greater than one), the (l−1)-th modified output sequence is modified to form a t-th modified output sequence having fewer mask tokens than the (l−1)-th modified output sequence. The T-th modified sequence constitutes the output sequence 114. (Note that in Algorithm 2 given below, the variable i corresponds to T−l+1).

In some implementations, the inference system 150 generates an output sequence 114 in an unconditioned manner, i.e., without conditioning on any conditioning input. In these implementations, the initial output sequence 113 is entirely made up of mask tokens, and the output sequences 114 generated by the diffusion model 110 approximate samples of a distribution of training sequences 126 included in the training data 120 that were used by the training system 100 to train the diffusion model 110.

In other implementations, the inference system 150 generates an output sequence 114 conditioned on a conditioning input 112. For example, the inference system 150 can receive a conditioning input 112 as part of, or in association with, the request and generate an output sequence 114 conditioned on the conditioning input 112.

In some of these implementations, the initial output sequence 113 is entirely made up of mask tokens, e.g., the inference system 150 can condition the diffusion model 110 on the conditioning input 112 while it is being used to progressively remove the mask tokens from the initial output sequence 113. For example, the diffusion model 110 can include one or more cross-attention layers that cross attend to the conditioning input 112.

In others of these implementations, the initial output sequence 113 includes mask tokens at a first subset of the plurality of output positions and conditioning tokens included in the conditioning input 112 at a second subset of the plurality of output positions.

The conditioning input 112 generally provides context for the output sequence 114. Like the output sequence 114, the conditioning input 112 can be a data sequence that includes one or more tokens selected from the vocabulary of tokens.

The conditioning input 112 can be received in any of a variety of ways. For example, the conditioning input 112 can be received as a user input. The user input can include a touchscreen input, a voice input, a keyboard input, a gesture input, a mouse, trackpad, or other pointing device input, that characterizes the task to be performed. As another example, the conditioning input 112 can be generated automatically, e.g., by an automated assistant or some other software applications that execute on a client device. As another example, the conditioning input 112 can be received as a user upload or obtained from a server.

In some cases, the inference system 150 can be a text generation system that generates text sequences, i.e., each output sequence 114 generated by the inference system 150 is an output sequence of text that includes a sequence of text tokens from a vocabulary of text tokens that includes, e.g., one or more of characters, sub-words, words, punctuation marks, numbers, or other symbols that appear in a natural language or a computer language. For example, the inference system 150 can generate text sequences in response to a request submitted by a user of the inference system 150 and provide the text sequences for presentation to the user which submitted the request.

In the context of text generation, the state-dependent masking schedule offers a significant technical advantage, particularly when the diffusion model is implemented on parallel processing hardware such as Graphics Processing Units (GPUs) or Tensor Processing Units (TPUs) which are adept at handling the simultaneous computations inherent in processing multiple sequence positions. The masked diffusion process, by allowing for the potential unmasking of multiple tokens at each update iteration, is already well-suited for such parallel architectures. The state-dependent masking schedule further improves this parallel generation capability by introducing an intelligent order to the unmasking process. For instance, by learning to prioritize the unmasking of syntactically crucial tokens (e.g., main verbs, subjects) or those tokens pivotal for establishing long-range dependencies earlier in the parallel generation steps, the model can construct grammatically sound and coherent narratives or responses more efficiently using the parallel hardware. This controlled unmasking order represents a technical improvement in how the computer system utilizes its parallel processing resources to generate high-quality textual data. This leads to text that is more reliably structured and therefore more directly usable for downstream technical tasks performed by computer systems, such as automated document summarization requiring high factual accuracy, machine translation demanding precise preservation of complex semantic meaning, or computer code generation that must strictly adhere to the syntax and operational logic of a programming language. The resulting enhancement in quality, often measurable by improved Bits Per Character metrics, signifies a more effective and resource-efficient operation of the computer system in producing technically useful linguistic outputs, as fewer overall processing cycles on the parallel hardware may be needed to achieve a target level of quality, or a higher quality can be achieved for a given computational budget.

In some of these cases, the inference system 150 can receive a conditioning input 112 as part of, or associated with, the request and generate an output sequence conditioned on the conditioning input, e.g., that is a response to the conditioning input.

The conditioning input may include a series of tokens selected from a vocabulary. This may be the same vocabulary as the vocabulary from which the tokens of the output sequence 114 are selected. For example, the conditioning input may include any two or more of text tokens, image tokens, audio tokens and biological tokens. In particular, it may include both text tokens and also image tokens and/or audio tokens. The image tokens, audio tokens and/or biological tokens may be based on data from the real-world, e.g. captured by a camera (still camera or video camera), microphone or chemical experiments in the real world.

For example, the conditioning input 112 can be an input sequence of text and the output sequence is another sequence of text, e.g., a translation of the input sequence of text, a completion of the input sequence of text, a paraphrase of the input sequence of text, a response to a question posed in the input sequence, or a sequence of text that is about a topic specified by the input sequence of text. As another example, the conditioning input 112 can comprise (or be) an input other than text, e.g., an image (e.g. in the form of image tokens), a video (e.g. in the form of image tokens for each frame), and/or audio data (e.g. in the form of audio tokens), and the output sequence 114 can comprise text that describes the image, video and/or audio data in the conditioning input 112. For example, the output sequence 114 can be the image and/or audio tokens of the conditioning input plus text tokens describing the image and/or audio data. The text tokens may optionally be presented to a user, e.g. on a screen or braille output device. Thus, the system generates text (e.g. for someone blind or deaf) describing the image and/or audio data.

As a particular example, the inference system 150 can be part of a dialog system and the conditioning input 112 can be a data sequence that includes audio and/or text tokens from the most recent conversational turn submitted by a user of the dialog system during the dialog while the output sequence of text is the next turn in the conversation, e.g., either text or audio tokens that are a response to the most recent conversational turn. Optionally, the conditioning input can also include audio and/or text tokens from one or more historical conversational turns that occurred earlier in the conversation. As another particular example, the inference system 150 can be part of a computer code generation system and the conditioning input 112 can be a text description of a desired piece of code or a snippet of computer code in a programming language and the output sequence of text can be computer code, e.g., a snippet of code that is described by the conditioning input or a snippet of code that follows the conditioning input in a computer program.

In some cases, the inference system 150 can be an image or video generation system that generates images or videos that each have multiple frames (where each frame is an image, which may be processed as an image in the way described below) as sequences of pixels, i.e., each output sequence 114 generated by the inference system 150 includes a sequence of color values for pixels in an output image arranged according to a specified order.

For image or video generation, the state-dependent masking schedule provides significant technical advantages, especially when the diffusion model is executed on parallel processing architectures like GPUs or TPUs, which excel at simultaneously processing large arrays of pixels or image patches. The inherent parallelism of the masked diffusion process, capable of unmasking multiple image regions concurrently at each update iteration, is further enhanced by the intelligent ordering imposed by the schedule. By learning to guide the parallel unmasking process to, for instance, establish global structures or salient object forms before rendering fine-grained textures or background details across multiple regions simultaneously, the system utilizes its parallel hardware more effectively. This controlled, parallel construction may lead to a technical improvement in the computer's ability to generate images and videos with superior spatial coherence, reduced visual artifacts, and more realistic depictions of complex scenes. For example, the system might learn to prioritize unmasking pixels that define the coarse outline of an object across parallel processing units before these units cooperatively fill in the interior textures. This results in a more efficient use of computational cycles on the parallel hardware to achieve a target level of image quality, reflected in better Bits Per Dimension scores. The generated visual data is thereby more suitable for demanding technical applications, such as creating high-fidelity synthetic datasets for robustly training and validating computer vision models (e.g., for autonomous driving systems where accurate scene representation is critical), or for accelerated industrial design and visualization where the computer system must rapidly produce realistic renderings.

In some cases, the inference system 150 can be an audio generation system that generates audio signals, e.g., each output sequence 114 is an output audio example that includes a sample of an audio wave at each of a sequence of output time steps that span a specified time window. For example, the output time steps can be arranged at regular intervals within the specified time window. The audio sample at a given output time step can be an amplitude value of the audio wave or an amplitude value that has been compressed, companded, or both. For example, the audio sample can be a raw amplitude value or a mu-law companded representation of the amplitude value. In audio generation, particularly for speech or music, the state-dependent masking schedule offers technical benefits that are amplified when the generation process is run on parallel hardware like GPUs or TPUs, suitable for processing multiple audio samples or temporal frames in parallel. The masked diffusion approach allows for simultaneous updates to different parts of the audio waveform or its tokenized representation. The controllable unmasking order, directed by the schedule, facilitates the system in leveraging this parallelism more effectively. For example, the model might learn to guide the parallel hardware to establish foundational rhythmic patterns, melodic contours, or dominant frequencies across multiple audio segments concurrently, before generating finer harmonic details or transient sounds within those segments. In speech synthesis, this could mean the parallel construction of an intonation contour across a phrase while simultaneously refining phonetic details. This technical approach results in a more efficient operation of the computer system, facilitating it in producing audio signals with improved temporal consistency and acoustic realism using its parallel processing capabilities. Audible artifacts, often resulting from less coordinated parallel generation, can be reduced. The technical effect is an audio output with higher fidelity and naturalness, generated with potentially fewer computational resources or in less time on the given hardware. This makes the system more effective for technical applications such as generating clearer and more engaging text-to-speech output for human-computer interfaces and accessibility tools, or providing composers and sound designers with tools that can rapidly produce coherent and high-quality audio material on standard computing hardware.

As another example, the conditioning input 112 that is received by the inference system 150 is an input sequence that represents data to be modified, e.g. image data, text data, audio data, or any other type of data; and the output sequence 114 a modified version of the data. The input and output sequences may each comprise any representation of the data to be modified/modified data e.g. symbols or embeddings generated/decoded by a respective neural network. In some examples, the input sequence can represent data to be compressed, denoised, restored, or edited, and the output sequence can represent the compressed, denoised, restored, or edited version of the data.

In some cases, the inference system 150 can be a biological sequence generation system that generates biological sequences, e.g., each output sequence 114 generated by the inference system 150 is a DNA sequence or a protein sequence. For example, the output sequence 114 that is a DNA sequence can include a plurality of tokens that represent nucleotides that make up a DNA molecule. As another example, the output sequence 114 that is a protein sequence can include a plurality of tokens that represent amino acids that make up a protein. The output sequence 114 may be used as basis for a subsequent step of fabricating a (real-world) chemical sample including a DNA sequence or protein sequence according to the output sequence 114. Alternatively or additionally, the conditioning input 112 may include data obtained experimentally from a (real-world) chemical sample, e.g. as a DNA sequence or a protein sequence comprised in the chemical sample.

The diffusion model 110 can have any appropriate architecture that allows it to, at any update iteration in the masked diffusion process, receive a diffusion model input includes an intermediate representation (e.g. the initial output sequence 113 or one of the updated intermediate representations) and a time index t, or an embedding of the time index t, that identifies the update iteration in the multiple update iterations, and to process the diffusion model input to generate a diffusion model output that defines or otherwise specifies, for each of the plurality of output positions, a respective score distribution over the plurality of tokens included in the vocabulary. The respective score distribution includes a respective score, e.g., a probability score, for each token in the vocabulary of tokens.

For example, when the output sequence represents an audio signal, an image, or a video that includes multiple video frames (where each video frame is an image), the diffusion model can have a convolutional neural network architecture that includes one or more convolution layers, e.g., a U-Net or another architecture.

As another example, when the output sequence is a text sequence, the diffusion model can be a Transformer neural network architecture that includes one or more attention layers, e.g., a Diffusion Transformer (DiT) architecture, or another attention-base architecture, e.g., a U-Net backbone with vision Transformers included in blocks corresponding to lower resolution levels.

Additional examples of the architectures of the diffusion model 110 include those described in Austin, Jacob, et al. “Structured denoising diffusion models in discrete state-spaces.” Advances in neural information processing systems 34 (2021): 17981-17993, and Lou, Aaron, et al. “Discrete diffusion modeling by estimating the ratios of the data distribution.” arXiv preprint arXiv:2310.16834 (2023).

In any example, the diffusion model 110 can include a softmax layer that generates the respective score distribution over the plurality of tokens included in the vocabulary for each of the plurality of output positions, e.g., that generates N probability vectors where N is the total number of output positions and each probability vector is a m-dimensional vector (m is vocabulary size, e.g. the number of elements of the vocabulary of the output sequence 114).

Prior to deployment of the diffusion model 110 at the inference system 150, the training system 100 trains the diffusion model 110 on a set of training sequences 126 obtained from a training dataset 120.

For example, the training sequences included in the training dataset 120 can be generated from a large dataset of text in one or more natural languages, e.g., text that is publicly available from the Internet or another text corpus, a large dataset of computer code in one or more programming languages, e.g., Python, C++, C #, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

More specifically, the training system 100 performs the training over a plurality of training iterations.

At each training iteration, the training system 100 obtains a batch of one or more training sequences 126 from the training dataset 120. Each training sequence 126 includes an original token at each of a plurality of output positions.

For each training sequence 126 in the batch, a masking engine 130 of the training system 100 generates a corresponding masked training sequence 136 by assigning mask tokens to one or more of the plurality of output positions in the training sequence 126 in accordance with a masked probability that is determined for each output position in the training sequence.

Then, the training system 100 trains the diffusion model 110 to update the values of the parameters 116 of the diffusion model 110 based on optimizing (that is, in each of multiple training iterations, modifying the values of the parameters 116 to modify, e.g., decrease or increase, the value of) a diffusion objective function that evaluates a quality of the diffusion model outputs generated by the diffusion model 110 from processing the masked training sequences 136.

By repeatedly performing the training iterations, the training system 100 repeatedly updates the values of the parameters of the diffusion model 110 to determine the trained values of the parameters 116 that will cause the diffusion model 110 to perform well on the unconditional or conditional output sequence generation tasks.

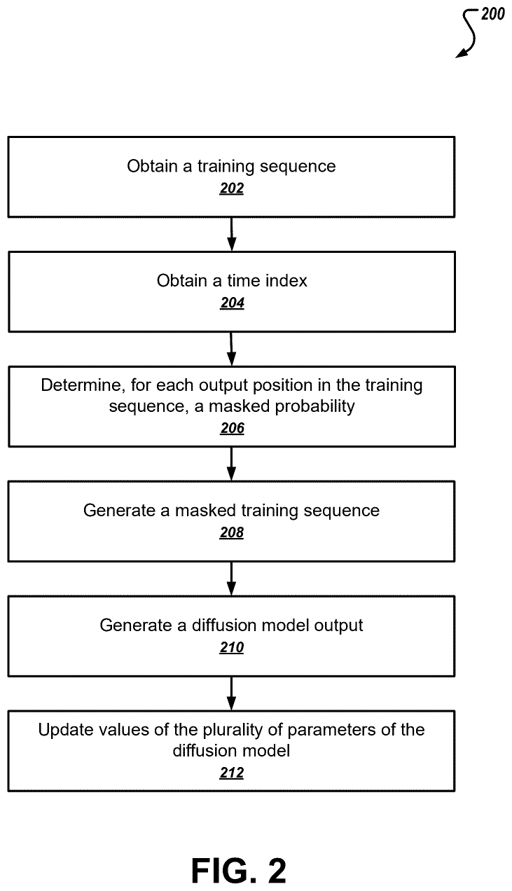

FIG. 2 is a flow diagram of an example process 200 for training a diffusion model that has a plurality of parameters. For convenience, the process 200 will be described as being performed by a system of one or more computers located in one or more locations. For example, a training system, e.g., the training system 100 depicted in FIG. 1, appropriately programmed in accordance with this specification, can perform the process 200.

FIG. 2 is described in conjunction with FIG. 3, which is an example illustration 300 of operations performed by the training system 100 of FIG. 1 to train the diffusion model 110.

The system can repeatedly perform iterations of the process 200 to repeatedly update the values of the plurality of parameters of the diffusion model until a termination criterion has been satisfied, e.g., until a threshold number of iterations of the process 200 have been performed, until a threshold amount of wall clock time has elapsed, or until the values of the plurality of parameters have converged (according to a convergence criterion).

The system obtains a batch of one or more training sequences (step 202). Each training sequence includes an original token at each of a plurality of output positions (step 202). For example, the system can sample the batch of training sequences from the training dataset that stores a larger number of training sequences. The system will generally obtain different training sequences at different iterations, e.g., by sampling a fixed number of training sequences from the larger number of training sequences at each iteration.

For each of the one or more training sequences in the batch, the system obtains a time index t for the training sequence (step 204). The time index t identifies a forward masking iteration in a forward masking process. The forward masking process corresponds to a data transformation process executed by the system during the training to transform a training sequence into a sequence of mask tokens, where the original tokens in a training sequence are progressively replaced with the mask tokens.

The forward masking process includes multiple forward masking iterations. In some implementations, there is an equal number of forward masking iterations in the forward masking process and multiple update iterations in the masked diffusion process.

For example, as illustrated in FIG. 3, the time index t can be any value within a predetermined range, e.g., [0,1], or a different range, and the system can obtain the time index t based on sampling a value from the predetermined range with some measure of randomness.

For each of the one or more training sequences in the batch, the system determines, for each output position in the training sequence, a masked probability of replacing the original token at the output position with a mask token at the forward masking iteration identified by the time index (step 206). In particular, the system determines the masked probability for each token in each training sequence independently of other tokens in the same or different training sequences.

For each original token in each training sequence, the masked probability is determined based at least on the time index t. In some implementations, the masked probability is determined also based on a value of a learnable parameter associated with the original token.

The inclusion of such learnable settings, which are specific to each type of token in the vocabulary, facilitate a data-driven and token-specific unmasking process. These settings, learned jointly with the diffusion model parameters, effectively allow the model to learn an optimal unmasking cadence for different types of tokens based on their role or characteristics within the training data. For example, tokens that are statistically more common or provide stronger contextual cues for subsequent tokens might be learned to be unmasked earlier. This adaptation of the unmasking process to the specific characteristics of the vocabulary and the training data may contribute to the improved generation quality, as a more efficient exploration of the data manifold during generation may be achieved, as the model learns to prioritize the generation of tokens that are more informative or structurally important at different stages of the diffusion process. This leads to a technical effect of reduced generation errors and improved coherence in the final output sequence, such as more globally consistent images.

In particular, for each original token in each training sequence, the masked probability can be determined by computing a masking schedule function αₜ that corresponds to the token. There is a total of m+1 masking schedule functions that correspond respectively to a set of tokens that include all tokens in the vocabulary and the mask token, where m is the size of the vocabulary (the total number of tokens included in the vocabulary). That is, each token in the vocabulary has its own corresponding masking schedule function αₜ. The mask token also has its own corresponding masking schedule function αₜ.

To determine the masked probabilities that are dependent on the values of the learnable parameters, the masking schedule function αₜ can be a function that is dependent on the values of the learnable parameters. Examples of the masking schedule function αₜ are provided below in TABLE 1.

For each of the one or more training sequences in the batch, the system generates a masked training sequence by assigning mask tokens to one or more of the plurality of output positions in the training sequence in accordance with the masked probabilities (step 208).

For example, as illustrated in FIG. 3, a training sequence 310 includes original tokens (illustrated as light colored squares) that are selected from the vocabulary and no mask tokens (illustrated as dark colored squares). A masked training sequence 320 includes the same number of output positions as the training sequence 310, but includes one or more mask tokens that were previously not included in the training sequence.

In particular, for each output position, the system determines whether to replace the original token at the output position with a mask token in accordance with the masked probability determined for the output position and, if the system determines that the original token should be replaced, the system proceeds to assign a mask token to occupy the output position that is previously occupied by the original token.

Thus, output positions that have higher masked probabilities are more likely to have the original tokens that occupy the output positions to be replaced by mask tokens than output positions that have lower masked probabilities. For example, the system can determine to replace the original token at the output position with a mask token with a probability of 1−αₜ (where αₜ is the masking schedule function for the token at the output position), and determine to keep the original token at the output position with a probability of αₜ. In some implementations, e.g., in the case of the functions with no learnable parameters, each of the m+1 masking schedule functions is the same.

For each of the one or more training sequences in the batch, the system processes a diffusion model training input using the diffusion model to generate a diffusion model training output (step 210).

The diffusion model training input includes the masked training sequence that has been generated based on the training sequence.

The diffusion model training input can also include the time index t, or an embedding of the time index t, that identifies the forward masking iteration in the forward masking process.

The diffusion model output defines or otherwise specifies, for each of the plurality of output positions in the training sequence, a respective training score distribution over the plurality of tokens included in the vocabulary. The respective training score distribution includes a respective training score, e.g., a probability score, for each token in the vocabulary of tokens.

The system updates values of the plurality of parameters of the diffusion model based on optimizing (modifying, e.g., decreasing or increasing the value of) a diffusion objective function (step 212).

The system can do this by computing gradients of the diffusion objective function with respect to the parameters θ of the diffusion model λ_{θ} and, in some implementations, the learnable parameters w associated with the tokens in the vocabulary, and then applying an appropriate optimizer, e.g., an Adam optimizer or an AdamW optimizer, to the gradients.

These gradients can generally be computed through backpropagation. In some implementations, to obtain unbiased gradients of the learnable parameters w, the system applies a REINFORCE leave-one-out (RLOO) technique to compute an estimation of the gradients of the diffusion objective function with respect to the learnable parameters w.

The diffusion objective function includes, for each of the one or more of the plurality of output positions in the masked training sequence, a loss term that evaluates a difference between (i) the respective training score for each token in the vocabulary of tokens and (ii) a predetermined score for each token in the vocabulary of tokens. For example, the loss term can be a cross-entropy loss term, in which case optimizing the diffusion objective function can involve decreasing the value of a loss computed using the diffusion objective function.

The predetermined score for each token in the vocabulary of tokens is a score that identifies whether the token is a ground truth token that previously occupied the output position in the training input sequence (based on which the masked training sequence is generated). For example, the predetermined score can be a higher score (e.g., one) for the ground truth token, and a lower score (e.g., zero) for each remaining token in the vocabulary.

For example, the diffusion objective function can be computed as a time-integral of weighted cross-entropy loss terms:

$${\int }_{0}^{1} \frac{{a}_{t}^{′}}{1 - {α}_{t}} {𝔼}_{q ( {x}_{t} \vert {x}_{0} )} [ {\sum }_{n : {x}_{t}^{( n )} = m} {( {x}_{0}^{( n )} )}^{T} log {μ}_{θ}^{( n )} ( {x}_{t} ) ] dt$$

where αₜ′ represents the derivative of the masking schedule function αₜ for a token in the masked training sequence with respect to time index

$$t , {x}_{t} = ( {x}_{t}^{( 1 )} , {x}_{t}^{( 2 )} , … , {x}_{t}^{( N )} )$$

represents a masked training sequence where N is the number of tokens in the masked training sequence, each element

$${x}_{t}^{( n )}$$

represents a token (either a token selected from the vocabulary, or a mask token), x₀ are the one-hot vectors that identify the original token at each output position, and μ_{θ} (xₜ) represents the diffusion model output (the respective training score distributions) generated by the diffusion model μ_{θ} in accordance the parameters θ from processing the diffusion model input that includes the masked training sequence xₜ.

The weight for each cross-entropy loss term in the weighted integral of cross-entropy loss terms is dependent at least on the time index t.

The ways in which the weights of the cross-entropy loss terms are determined can vary depending on the masking schedule functions that are used to determine the masked probabilities.

A few examples of the masking schedule function, as well as how the weights of the cross-entropy loss terms can be determined, are provided below in TABLE 1.

TABLE 1

| Masking schedules | αₜ | $Cross - entropy loss weight \frac{{α}_{t}^{′}}{1 - {α}_{t}}$ |
|---|---|---|
| Linear | 1 − t | $- \frac{1}{t}$ |
| Polynomial | 1 − t^{w} | $- \frac{w}{t}$ |
| Geometric | $exp ( - {\overline{β}}_{min}^{1 - t} {\overline{β}}_{max}^{t} )$ | $\begin{matrix}- \frac{exp ( - {\overline{β}}_{min}^{1 - t} {\overline{β}}_{max}^{t} )}{1 - exp ( - {\overline{β}}_{min}^{1 - t} {\overline{β}}_{max}^{t} )} \\ {\overline{β}}_{min}^{1 - t} {\overline{β}}_{max}^{t} log \frac{{σ}_{min}}{{σ}_{max}}\end{matrix}$ |
| Cosine | $1 - cos ( \frac{π}{2} ( 1 - t ) )$ | $- \frac{π}{2} tan ( \frac{π}{2} ( 1 - t ) )$ |

In table 1, the masking schedule function in row 2 that is in the form of the polynomial function, where w represents a learnable parameter associated with a token in the vocabulary, is an example of a masking schedule function that can be used to compute the masked probability based on a value of a learnable parameter associated with the original token. In TABLE 1, the masking schedule functions αₜ vary over the m+1 tokens in the polynomial case, but for the other cases each of the masking schedule functions αₜ is the same.

In the masking schedule function in row 3 that is in the form of the geometric function, B̅ₘᵢₙ and B̅ₘₐₓ are tunable parameters for each token that can take any value. For example, B̅ₘᵢₙ=10⁻⁵ and B̅ₘᵢₙ=20. σ(x) represents the sigmoid function

$$\frac{1}{1 + {e}^{- x}} .$$

In any of these examples, each cross-entropy loss term in the weighted integral of cross-entropy loss terms is weighted by a weight for each token that is dependent at least on the time index t. In the case of the polynomial function, the weight for each token is also dependent at least on the value of a learnable parameter w for the token.

As another example, when the masked probabilities are dependent on the value of the learnable parameters, the diffusion objective function can be computed as a score entropy loss function:

$${\int }_{t ( 1 )}^{1} β ( t ) {𝔼}_{{q}_{t \vert 0} ( k \vert {x}_{0} )} [ {δ}_{mk} ( {\sum }_{j \neq k} {{s}_{θ} ( k )}_{j} - \frac{{α}_{t}}{1 - {α}_{t}} {x}_{0}^{T} log {μ}_{θ} ( k ) ] + \frac{{α}_{t}}{1 - {α}_{t}} ) dt \\ where$$

$${s}_{θ} {( {x}_{t} )}_{j} = \frac{{α}_{t}}{1 - {α}_{t}} {{μ}_{θ} ( {x}_{t} )}^{T} {e}_{j} and \\ {\sum }_{j \neq m} {{s}_{θ} ( m )}_{j} = \frac{{α}_{t}}{1 - {α}_{t}} .$$

An example algorithm of a single iteration for training the diffusion model is shown below, where line 3 corresponds to step 204 of process 200 (it provides a specific example of how to determine the time index t), line 4 corresponds to steps 206-208 of process 200, and lines 5 corresponds to steps 210-212 of process 200 (where the diffusion objective function is computed as a time-integral of weighted cross-entropy loss terms).

Algorithm 1 A single step of training with MD4.

```
$Input : data minibatch {\{ {x}_{t}^{i} \}}_{i = 1}^{B} , network {μ}_{θ} ( \cdot , t ) , masking schedule {α}_{t}$
for i = 1, . . . , B do (in parallel):
  tᵢ ← mod(u + i/B, 1), u ~ U[0, 1]
  $for n ∈ [ N ] , mask out each token {x}_{0}^{i , ( n )} independently with probability 1 - {α}_{{t}_{i}} to obtain {x}_{{t}_{i}}^{i}$
  $for n ∈ [ N ] , if {x}_{{t}_{i}}^{( n )} = m , compute weighted cross entropy loss \frac{{α}_{{t}_{i}}^{′}}{1 - {α}_{{t}_{i}}} {( {x}_{0}^{i , ( n )} )}^{⊤} log {μ}_{θ}^{( n )} ( {x}_{{t}_{i}}^{i} , {t}_{i} )$
Sum over all weighted cross entropy losses for mask positions and optimize via autodiff
```

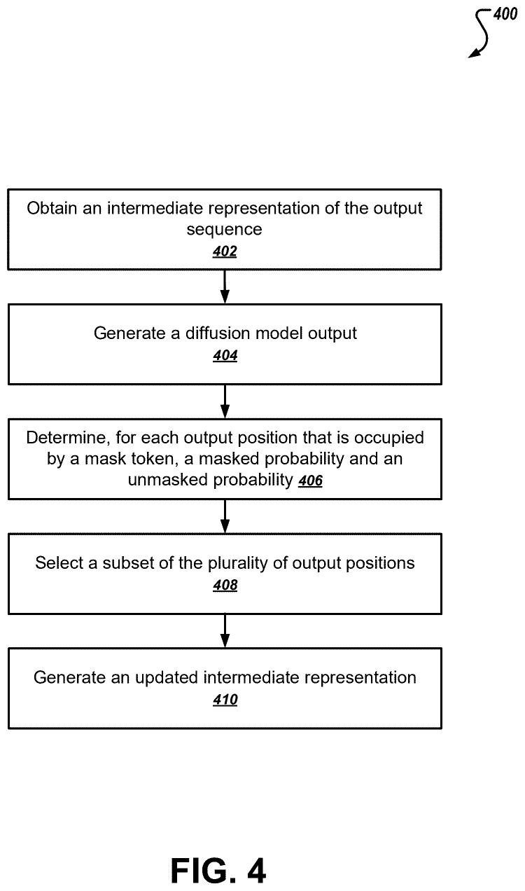

FIG. 4 is a flow diagram of an example process 400 for generating an output sequence by using a diffusion model to perform a masked diffusion process. For convenience, the process 400 will be described as being performed by a system of one or more computers located in one or more locations. For example, an inference system, e.g., the inference system 150 depicted in FIG. 1, appropriately programmed in accordance with this specification, can perform the process 400.

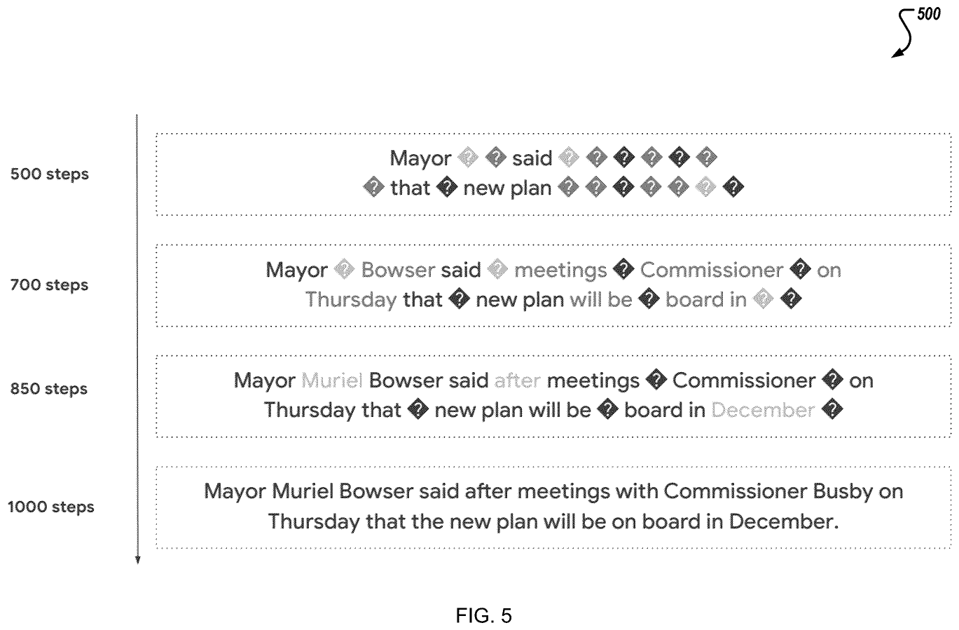

FIG. 4 is described in conjunction with FIG. 5, which is an example illustration 500 of generating an output sequence by using the diffusion model 110 of FIG. 1.

An iteration of the process 400 corresponds to an update iteration in the masked diffusion process. The masked diffusion process corresponds to a data transformation process executed by the system during inference to transform an initial output sequence that includes mask tokens into an output sequence that includes tokens selected from the vocabulary.

In other words, to generate the output sequence, the system obtains an initial output sequence and then repeatedly performs multiple iterations of the process 400 that correspond respectively to the multiple update iterations to progressively update the initial output sequence. The output sequence is generated after the last update iteration in the masked diffusion process.

The output sequence includes a plurality of output positions and, for each of the plurality of output positions, a respective token that occupies the output position. The respective token can be any token selected from a vocabulary of tokens.

The initial output sequence includes a mask token at each of at least a subset of the plurality of output positions (an “initial subset”). In contrast, the output sequence generated after the last update iteration in the masked diffusion process will include no mask tokens.

When configured as an unconditional output sequence generation system, the system can generate an initial output sequence that includes only mask tokens. That is, each of the plurality of output positions in the initial output sequence is occupied by a mask token.

When configured as a conditional output sequence generation system, the system can generate an initial output sequence based on a conditioning input received by the system. The conditioning input includes tokens selected from the vocabulary of tokens. Thus, for example, each of a first subset of the plurality of output positions in the initial output sequence is occupied by a mask token, while each of a second subset of the plurality of output positions in the initial output sequence is occupied by a token selected from the vocabulary of tokens.

The system obtains an intermediate representation of the output sequence as of the update iteration (step 402). The intermediate representation has the same dimensionality, i.e., includes the same number of output positions, as the initial output sequence and the output sequence.

At the first (beginning) update iteration in the multiple update iterations, the intermediate representation can be the initial output sequence that has been generated prior to the mask diffusion process. At each subsequent update iteration in the multiple update iterations, the intermediate representation can be an updated intermediate representation generated in an immediately preceding update iteration.

The system processes a diffusion model input using the diffusion model to generate a diffusion model output (step 404).

The diffusion model input includes the intermediate representation.

The diffusion model input can also include a time index t, or an embedding of the time index t, that identifies an update iteration in the multiple update iterations. The time index t can take any value within a predetermined range. For example, t ∈ [0,1], or a different range. The time index may be a predetermined respective value for each update iteration, and may be such that for successive iterations the time index t may vary (increase or decrease) monotonously.

The diffusion model output defines or otherwise specifies, for each of the plurality of output positions, a respective score distribution over the plurality of tokens included in the vocabulary. The respective score distribution includes a respective score, e.g., a probability score, for each token in the vocabulary of tokens.

The system determines, for each output position in the intermediate representation of the output sequence that is occupied by a mask token, a masked probability and an unmasked probability (step 406). In some implementations, the system does not determine a masked probability or an unmasked probability for any output position that is not occupied by a mask token. Thus, in these implementations, once a token has been selected from the vocabulary to occupy an output position, the system will not update that output position again in any subsequent update iteration in the masked diffusion process.

The masked probability defines, for each token of the vocabulary, a probability that the output position remains to be occupied by the mask token, and does not become occupied by that token of the vocabulary.

For any output position in the intermediate representation of the output sequence that is occupied by a mask token, such a masked probability is computed based on the time index t and, in some implementations, the value of the learnable parameter associated with the token. The values of these learnable parameters have been learned jointly with the values of the parameters of the diffusion model on a plurality of training sequences, as discussed above with reference to FIG. 2

The unmasked probability defines, for each token of the vocabulary, a probability that the output position ceases to be occupied by the mask token, and becomes occupied by that token of the vocabulary.

For any output position in the intermediate representation of the output sequence that is occupied by a mask token, such an unmasked probability is computed as a weighted combination of the respective score for each token in the vocabulary of tokens that has been generated by using the diffusion model for the output position, where each respective score in the weighted combination is weighted by a weight that is dependent on the time index t and, in some implementations, the value of the learnable parameter associated with the token.

For example, the system can compute a reverse transition probability that is in the form of:

$$Cat ( \frac{{α}_{s} - {α}_{t}}{1 - {α}_{t}} {μ}_{θ}^{( n )} ( {x}_{t} , t ) + \frac{1 - {α}_{s}}{1 - {α}_{t}} {e}_{m} )$$

where the masked probability is computed as:

$$\frac{1 - {α}_{s}}{1 - {α}_{t}} {e}_{m}$$

where the unmasked probability is computed as:

$$\frac{{α}_{s} - {α}_{t}}{1 - {α}_{t}} {μ}_{θ}^{( n )} ( {x}_{t} , t )$$

and where Cat (:) represents a categorical distribution, where

$${x}_{t} = ( {x}_{t}^{( 1 )} , {x}_{t}^{( 2 )} , … , {x}_{t}^{( N )} )$$

where each element

$${x}_{t}^{( n )}$$

represents a token (either a token selected from the vocabulary, or a mask token), t represents the time index that identifies the current update iteration in the multiple update iterations, and s represents the time index that identifies a subsequent update iteration that follows the current update iteration in the multiple update iterations.

μ_{θ}(xₜ, t) represents the diffusion model output generated by the diffusion model μ_{θ} in accordance the parameters θ from processing the diffusion model input (xₜ, t). The diffusion model input (xₜ, t) includes the intermediate representation xₜ, and the time index t. In some implementations, μ_{θ}(xₜ, t) is a m+1 component vector having a component for each token in the vocabulary and the mask token.

eₘ is a one-hot vector of size m+1 with the m^{th} element being one (and remaining elements being zero), where m is the size of the vocabulary (the total number of tokens included in the vocabulary). In some implementations, the components of the one-hot vector are numbered from 0 to m.

αₜ represents a masking schedule function that corresponds to a token. There is a total of m+1 masking schedule functions that correspond respectively to a set of tokens that include all tokens in the vocabulary and the mask token.

For each token in the vocabulary, the corresponding masking schedule function αₜ can be any function that depends on the time index t and, in some implementations, the value of the learnable parameter associated with the token.

For example, for each token in the vocabulary, the corresponding masking schedule function αₜ can be a polynomial function that is in the form of:

$${α}_{t , i} = 1 - {t}^{{{w}_{i}}_{}}$$

where t represents the time index that identifies the current update iteration in the multiple update iterations, i labels the current update iteration in the multiple update iterations, and w represents the learnable parameter associated with the token.

The system selects a subset of the plurality of output positions in the output sequence to be unmasked based on the masked and unmasked probabilities that have been determined for each output position in the intermediate representation of the output sequence that is occupied by the mask token (step 408).

The system can make this selection by sampling from the output positions in the intermediate representation of the output sequence that are occupied by the mask tokens in accordance with the reverse transition probability. There are many ways in which the system can perform the sampling. For example, the system can apply an ancestral sampler. As another example, the system can apply a sampler that uses a Euler discretization method.

In particular, when determining which output positions in the intermediate representation of the output sequence should be included in the subset, the system prioritizes for selection of output positions in the output sequence that have relatively lower masked probabilities over output positions in the output sequence that have relatively higher masked probabilities. The system also prioritizes for selection of output positions in the output sequence that have relatively higher unmasked probabilities over output positions in the output sequence that have relatively lower unmasked probabilities.

The system generates an updated intermediate representation of the output sequence (step 410). The system can do this by selecting, for each output position in the subset and based on the diffusion model output generated by the diffusion model, a respective token from the vocabulary of tokens to occupy the output position.

In some implementations, because the diffusion model output defines, for each output position in the subset, a respective score for each token in the vocabulary of tokens, the token to occupy the output position can be determined by greedily selecting the highest-scoring token or through sampling, e.g., using nucleus sampling or another sampling technique, from the respective scores defined by the diffusion model output.

The updated intermediate representation of the output sequence for the update iteration can then be generated by replacing the mask tokens at the output positions in the subset with the selected tokens, i.e., by including the selected tokens in place of the mask tokens. The updated intermediate representation thus includes fewer mask tokens than the intermediate representation.

If the update iteration is not the last update iteration, then another iteration of the process 400 will be performed. Alternatively, if the update iteration is the last update iteration in the masked diffusion process, then the updated intermediate representation can be used to generate the final output sequence.

For example, the system can use the updated intermediate representation directly as the final output sequence. As another example, the system can further process the updated intermediate representation, e.g., to remove tokens that occupy the second subset of the plurality of output positions (i.e., tokens that are part of the conditioning input received by the system), and use the further processed updated intermediate representation as the final output sequence.

As shown in FIG. 5, the updated intermediate representations generated at the 500^{th}, 700^{th}, and 850^{th} update iterations include progressively smaller numbers of mask tokens (each illustrated as a rhombus with a question mark) and then, the updated intermediate representation of the output sequence generated at the 1000^{th} update iteration, which is used as the output sequence, includes no mask tokens at all.

In the example of FIG. 5, the tokens are word pieces, e.g., generated by tokenizing the training data using a word piece model, e.g., the GPT-2 tokenizer, the SentencePiece model, or another appropriate word piece tokenizer.

For example, the updated intermediate representation generated at the 500^{th} update iteration reads “Mayor [mask] [mask] said [mask] [mask] [mask] [mask] [mask] [mask] [mask] that [mask] new plan [mask] [mask] [mask] [mask] [mask] [mask] [mask].”

By repeatedly performing iterations of the process 400 that correspond respectively to the multiple update iterations to select output positions to be unmasked and then replacing the mask tokens occupying these selected output positions with tokens selected from the vocabulary, the system can generate an updated intermediate representation that includes fewer mask tokens.

For example, the updated intermediate representations generated at the 850^{th} update iteration reads “Mayor Muriel Bowser said after meetings [mask] Commissioner [mask] on Thursday that [mask] new plan will be [mask] board in December [mask].”

An example algorithm for generating the output sequence by using the diffusion model neural network is shown below. Line 5 defines that the system will only update an output position in any update iteration that is currently occupied by a mask token. Once a token has been selected from the vocabulary to occupy an output position, the system will not update that the output position again in any subsequent update iteration in the masked diffusion process.

Algorithm 2 Unconditional and conditional generation (e.g., infilling) with MD4.

```
Input: Context sequence x^{c} of length N, with masks indicating the target areas for generation
$Init : {\{ t ( i ) \}}_{i = 0}^{T} ← discretize ( [ 0 , 1 ] ) , {x}_{t ( T )} ← {x}^{c}$
for i = T, T − 1, . . . , 1 do
  t ← t(i), s ← t(i − 1)
  $for n ∈ [ N ] , if {x}_{t}^{( n )} = m , draw {x}_{s}^{( n )} \sim Cat ( \frac{{α}_{s} - {α}_{t}}{1 - {α}_{t}} {μ}_{θ}^{( n )} ( {x}_{t} , t ) + \frac{1 - {α}_{s}}{1 - {α}_{t}} {e}_{m} ) else {x}_{s}^{( n )} ← {x}_{i}^{( n )}$
return x₀.
```

Once generated, the final output sequence can be provided to the user. Additionally or alternatively, the system can provide the final output sequence to another system for further processing, or store the final output sequence in a storage device for some future purpose.

For example, the system can provide the final output sequence for presentation in a user interface of a user device, e.g., the user device through which the user submitted the request for output sequence.

As another example, the system can be implemented as part of or can be in communication with a digital assistant device, e.g., a mobile device, a smartwatch or other wearable device, or a smart speaker device, and the digital assistant device can provide the final output sequence to the user, e.g., by generating speech representing the final output sequence and playing back the speech to the user over a speaker.

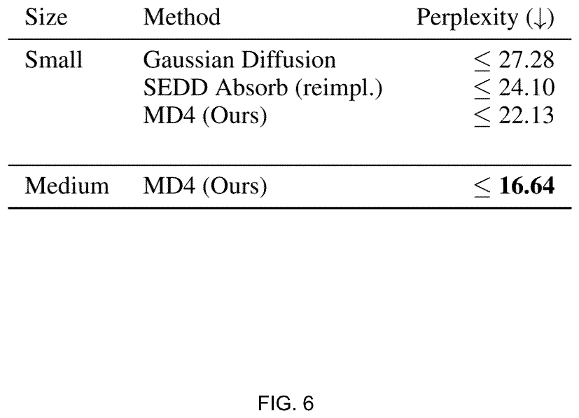

FIG. 6 shows an example of the performance of the diffusion model 110 of FIG. 1 on a text generation task.

In particular, FIG. 6 shows the perplexity of the diffusion model 110 (MD4) on the Open WebText validation set in comparison to a Gaussian diffusion model (e.g., described in Jacob Austin, Daniel D Johnson, Jonathan Ho, Daniel Tarlow, and Rianne Van Den Berg. Structured denoising diffusion models in discrete state-spaces. In Advances in Neural Information Processing Systems, 2021) and a score entropy discrete diffusion (SEDD) model (e.g., described in Aaron Lou, Chenlin Meng, and Stefano Ermon. Discrete diffusion language modeling by estimating the ratios of the data distribution. In International Conference on Machine Learning, 2024). Small and medium models differ in model sizes, with the small MD4, the Gaussian diffusion model, and the SEDD model each having about 90M (non-embedding) parameters and medium MD4 having about 320M (non-embedding) parameters.

A lower perplexity indicates higher accuracy, and correspondingly, a better performance of the model. It will be appreciated that MD4 models achieve lower perplexity, and correspondingly, a better performance relative to the Gaussian diffusion model and the SEDD model.

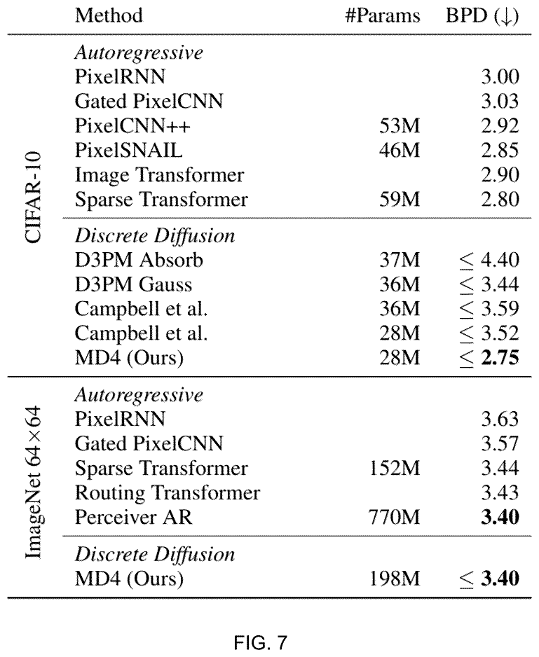

FIG. 7 shows an example of the performance of the diffusion model 110 of FIG. 1 on an image generation task.

In particular, FIG. 7 shows the Bits Per Dimension (BPD) metric of the diffusion model 110 (MD4) on the CIFAR-10 image dataset and the ImageNet 64×64 image dataset in comparison to various existing auto-regressive models and discrete diffusion models.

A Bits Per Dimension (BPD) indicates higher image quality, and correspondingly, a better performance of the model. It will be appreciated that MD4 models achieve lower BPD, and correspondingly, a better performance relative to these existing auto-regressive models and discrete diffusion models.

The existing auto-regressive models include the PixelRNN model described in Aaron Van Den Oord, Nal Kalchbrenner, and Koray Kavukcuoglu. Pixel recurrent neural networks. In International Conference on Machine Learning, 2016, the Gated PixelRNN model described in Aaron Van den Oord, Nal Kalchbrenner, Lasse Espeholt, Oriol Vinyals, and Alex Graves. Conditional image generation with pixelcnn decoders. In Advances in Neural Information Processing systems, 2016, the PixelCNN++ model described in Tim Salimans, Andrej Karpathy, Xi Chen, and Diederik P Kingma. Pixelcnn++: Improving the pixelcnn with discretized logistic mixture likelihood and other modifications. In International Conference on Learning Representations, 2016, the PixelSNAIL model described in Xi Chen, Nikhil Mishra, Mostafa Rohaninejad, and Pieter Abbeel. Pixelsnail: An improved autoregressive generative model. In International Conference on Machine Learning, 2018, the Image Transformer model described in Niki Parmar, Ashish Vaswani, Jakob Uszkoreit, Lukasz Kaiser, Noam Shazeer, Alexander Ku, and Dustin Tran. Image transformer. In International Conference on Machine Learning, 2018, the Image Transformer model described in Rewon Child, Scott Gray, Alec Radford, and Ilya Sutskever. Generating long sequences with sparse transformers. arXiv preprint arXiv:1904.10509, 2019, and the Routing Transformer model described in Aurko Roy, Mohammad Saffar, Ashish Vaswani, and David Grangier. Efficient content-based sparse attention with routing transformers. Transactions of the Association for Computational Linguistics, 9:53-68, 2021.

The existing discrete diffusion models include the D3PM models described in Jacob Austin, Daniel D Johnson, Jonathan Ho, Daniel Tarlow, and Rianne Van Den Berg. Structured denoising diffusion models in discrete state-spaces. In Advances in Neural Information Processing Systems, 2021 and the discrete denoising models described in Andrew Campbell, Joc Benton, Valentin De Bortoli, Thomas Rainforth, George Deligiannidis, and Arnaud Doucet. A continuous time framework for discrete denoising models. In Advances in Neural Information Processing Systems, 2022.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for generating an output sequence that comprises a respective token selected from a vocabulary of tokens at each of a plurality of output positions, wherein the method comprises:
obtaining an initial output sequence, the initial output sequence comprising a mask token at each of at least an initial subset of the plurality of output positions;
repeatedly performing the following at each of multiple update iterations:
obtaining an intermediate representation of the output sequence;
processing a diffusion model input that comprises the intermediate representation using the diffusion model to generate a diffusion model output that comprises, for each of the plurality of output positions, a respective score for each token in at least a subset of the vocabulary of tokens;
determining, for each output position in the output sequence that is occupied by a mask token and based on the intermediate representation, a masked probability that defines a probability of the output position remaining to be occupied by the mask token;
selecting a subset of the plurality of output positions in the output sequence to be unmasked based on the masked probability that has been determined for each output position in the output sequence that is occupied by the mask token; and
generating an updated intermediate representation of the output sequence, wherein generating the updated intermediate representation comprises selecting, for each output position in the subset and based on the diffusion model output generated by the diffusion model, a respective token from the vocabulary of tokens to occupy the position.

2. The method of claim 1, further comprising determining an unmasked probability that defines a probability of the output position ceasing to be occupied by the mask token, wherein determining the unmasked probability comprises:
computing a weighted combination of the respective score for each token at least the subset of in the vocabulary of tokens, wherein each respective score in the weighted combination is weighted by a weight that is dependent on a learnable parameter associated with the token.

3. The method of claim 1, wherein the weight is also dependent on a time index that identifies an update iteration in the multiple update iterations.

4. The method of claim 1, wherein selecting the subset of the plurality of output positions in the output sequence to be unmasked based on the masked probability that has been determined for each output position in the output sequence that is occupied by the mask token comprises:
selecting one or more output positions in the output sequence to be included in the subset by prioritizing for selection output positions in the output sequence that have relatively lower masked probabilities.

5. The method of claim 1, wherein selecting, for each output position in the subset and based on the diffusion model output generated by the diffusion model, the respective token from the vocabulary of tokens to occupy the position comprises:
selecting, as the respective token to occupy the position, a token from the vocabulary of tokens in accordance with the respective score for each token in at least the subset of the vocabulary of tokens that has been generated by the diffusion model.

6. The method of claim 1, wherein the respective score for each token in at least the subset of the vocabulary of tokens is a probability score generated by a softmax layer of the diffusion model.

7. The method of claim 1, wherein the diffusion model has been trained jointly with the learnable parameters on a plurality of masked training sequences that each include mask tokens, the mask tokens being added based on original tokens included in a plurality of training sequences.

8. The method of claim 7, wherein training the diffusion model comprises:
obtaining a training sequence that includes an original token at each of a plurality of output positions;
obtaining a time index that identifies a forward masking iteration;
determining, for each output position in the training sequence, a masked probability of replacing the original token at the output position with a mask token based on the time index; and
generating a masked training sequence by assigning mask tokens to one or more of the plurality of output positions in the training sequence in accordance with the masked probabilities.

9. The method of claim 7, wherein training the diffusion model comprises:
processing the masked training sequence using the diffusion model to generate a diffusion model output that comprises, for each of the one or more of the plurality of output positions in the masked training sequence, a respective training score for each token in at least the subset of the vocabulary of tokens; and
updating values of parameters of the diffusion model based on optimizing a diffusion objective function that comprises a weighted integral of cross-entropy loss terms, the cross-entropy loss terms comprising, for each of the one or more of the plurality of output positions in the masked training sequence, a cross-entropy loss term that evaluates a difference between (i) the respective training score for each token in at least the subset of the vocabulary of tokens and (ii) a predetermined score for each token in at least the subset of the vocabulary of tokens.

10. The method of claim 9, wherein in the weighted integral of cross-entropy loss terms, each cross-entropy loss term is weighted by a weight that is dependent on the time index.

11. The method of claim 7, wherein training the diffusion model jointly with the learnable parameters comprises:
computing gradients of the diffusion objective function with respect to the learnable parameters using a REINFORCE leave-one-out (RLOO) technique.

12. The method of claim 1, wherein the tokens comprise tokens that represent text characters, symbols, or audio signals.

13. The method of claim 1, wherein the tokens comprise tokens that represent image data, video data, or audio data.

14. The method of claim 1, wherein the tokens comprise tokens that represent biological data.

15. The method of claim 14, wherein the biological data comprises nucleotides or amino acids.

16. The method of claim 1, further comprising providing a final output sequence generate after the multiple update iterations for presentation on a display device.

17. A computer-implemented method for training a diffusion model having a plurality of parameters, wherein the method comprises:
obtaining a training sequence that includes an original token at each of a plurality of output positions;
obtaining a time index that identifies a forward masking iteration;
determining, for each output position in the training sequence, a masked probability of replacing the original token at the output position with a mask token based on the time index;
generating a masked training sequence by assigning mask tokens to one or more of the plurality of output positions in the training sequence in accordance with the masked probabilities;
processing the masked training sequence using the diffusion model to generate a diffusion model output that comprises, for each of the one or more of the plurality of output positions in the masked training sequence, a respective training score for each token in at least the subset of the vocabulary of tokens; and
updating values of the plurality of parameters of the diffusion model based on optimizing a diffusion objective function that comprises a weighted integral of cross-entropy loss terms, the cross-entropy loss terms comprising, for each of the one or more of the plurality of output positions in the masked training sequence, a cross-entropy loss term that evaluates a difference between (i) the respective training score for each token in at least the subset of the vocabulary of tokens and (ii) a predetermined score for each token in at least the subset of the vocabulary of tokens.

18. The method of claim 17, wherein in the weighted integral of cross-entropy loss terms, each cross-entropy loss term is weighted by a weight that is dependent on the time index.

19. A system comprising one or more computers and one or more storage devices storing instructions that are operable, when executed by the one or more computers, to cause the one or more computers to perform operations for generating an output sequence that comprises a respective token selected from a vocabulary of tokens at each of a plurality of output positions, wherein the operations comprise:
obtaining an initial output sequence, the initial output sequence comprising a mask token at each of at least an initial subset of the plurality of output positions;
repeatedly performing the following at each of multiple update iterations:
obtaining an intermediate representation of the output sequence;
processing a diffusion model input that comprises the intermediate representation using the diffusion model to generate a diffusion model output that comprises, for each of the plurality of output positions, a respective score for each token in at least a subset of the vocabulary of tokens;
determining, for each output position in the output sequence that is occupied by a mask token and based on the intermediate representation, a masked probability that defines a probability of the output position remaining to be occupied by the mask token;
selecting a subset of the plurality of output positions in the output sequence to be unmasked based on the masked probability that has been determined for each output position in the output sequence that is occupied by the mask token; and
generating an updated intermediate representation of the output sequence, wherein generating the updated intermediate representation comprises selecting, for each output position in the subset and based on the diffusion model output generated by the diffusion model, a respective token from the vocabulary of tokens to occupy the position.

20. A non-transitory computer storage medium encoded with instructions that, when executed by one or more computers, cause the one or more computers to perform operations for generating an output sequence that comprises a respective token selected from a vocabulary of tokens at each of a plurality of output positions, wherein the operations comprise:
obtaining an initial output sequence, the initial output sequence comprising a mask token at each of at least an initial subset of the plurality of output positions;
repeatedly performing the following at each of multiple update iterations:
obtaining an intermediate representation of the output sequence;
processing a diffusion model input that comprises the intermediate representation using the diffusion model to generate a diffusion model output that comprises, for each of the plurality of output positions, a respective score for each token in at least a subset of the vocabulary of tokens;
determining, for each output position in the output sequence that is occupied by a mask token and based on the intermediate representation, a masked probability that defines a probability of the output position remaining to be occupied by the mask token;
selecting a subset of the plurality of output positions in the output sequence to be unmasked based on the masked probability that has been determined for each output position in the output sequence that is occupied by the mask token; and
generating an updated intermediate representation of the output sequence, wherein generating the updated intermediate representation comprises selecting, for each output position in the subset and based on the diffusion model output generated by the diffusion model, a respective token from the vocabulary of tokens to occupy the position.
